(19) United States
(12) Patent Application Publication
(10) Pub. No.: US 2006/0130336 A1
(43) Pub. Date: Jun. 22, 2006

(54) Food cutting and serving utensil

(76) Inventors: Scott A. F. Christensen, Biwabik, MN (US); Rita R. Licari, Biwabik, MN (US)

Correspondence Address: Raymond M. Galasso;Galasso & Associates LP, P.O. Box 26503, Austin, TX, 78755-0503, US

(21) Appl. No.: 11/313,212

(22) Filed: Dec. 20, 2005

Related U.S. Application Data
(60) Provisional application No. 60/637,828, filed on Dec. 21, 2004.

(51) Int. Cl. B26B 3/00

(52) U.S. Cl. 30/142; 30/319

(57) ABSTRACT

The present invention is a food cutting and serving device which includes an elongated handle with a cutting wheel attached to one end of the handle and a serving device or spatula attached to the second end of the handle. The cutting wheel is attached to the handle with a pin or axle to facilitate the rotation of the wheel cutter. The serving device is generally triangular and is secured to the handle with a hinge to facilitate the folding of the serving device proximate the handle between and open position and a closed position.

### PRIORITY UNDER 35 U.S.C. §119(e) & 37 C.F.R. §1.78

This nonprovisional application claims priority based upon the following prior U.S. provisional patent application No. 60/637,828, entitled: Pizza pal, filed Dec. 21, 2004, in the names of Rita Licari and Scott Christensen, which is hereby incorporated by reference for all purposes.

### FIELD OF THE INVENTION

The present invention relates to a device for cutting and serving food, and more specifically but not by way of limitation, to a device having an elongated handle with a rotary pizza cutting device at one end and a foldable serving utensil at the other end, to facilitate the cutting and serving of food such as a pizza.

### BACKGROUND

Pizza is one of the most popular types of food, not only in the United States, but also around the world. Many people enjoy eating pizza because of the combination of bread with rich tomato sauce and layers of melted cheese. They also enjoy being able to place a variety of items on the pizza, aside from the basics, such as vegetables, various meats, and different types of sauces. Many people prefer to eat pizza hot, but many others will also eat pizza cold. Pizza can be eaten as a meal or may be consumed for a quick snack.

The popularity of pizza has caused many people to open restaurants, which primarily market pizzas. Many of these establishments will also deliver pizzas, as well as other items, to a person's home making pizza an extremely convenient meal. Pre-made pizzas are also available in most grocery stores and require only a few minutes to prepare, making them a preferred meal for people leading busy lifestyles.

Pizzas are generally produced in a circular shape, and subsequently cut into generally triangular shaped pieces. The problem individuals experience when preparing and serving pizza, is the need to retrieve separate utensils for cutting and serving the slices. A pizza cutter or knife is often used to divide the pizza in slices, and a separate spatula or other similar tool is used to lift the slice of pizza from the serving dish and onto an individual's plate. The need for two separate utensils creates more for the individual to clean up after the meal is consumed and also takes up more storage space in the individual's kitchen.

Accordingly there is a need for a device that can facilitate the cutting and serving of food, such as pizza, and minimize the amount of space required for storage of the device.

### SUMMARY OF THE INVENTION

The present invention is a food cutting and serving device which includes an elongated handle with a cutting device attached to one end of the handle and a serving device attached to the second end of the handle. The cutting device includes a wheel cutter and is attached to the handle with a pin or axle to facilitate the rotation of the wheel cutter. The serving device includes a generally triangular spatula that is secured to the handle with a hinge to facilitate the folding of the spatula proximate the handle between and open position and a closed position. The closed position helps to minimize the amount of space needed to store the overall device.

### BRIEF DESCRIPTION OF THE DRAWINGS

A more complete understanding of the present invention may be had by reference to the following Detailed Description and appended claims when taken in conjunction with the accompanying Drawings wherein:

FIG. 1 illustrates a top perspective view of an embodiment of the present invention with the spatula in the open position; and

FIG. 2 illustrates a top perspective view of an embodiment of the present invention with the spatula in the closed position.

### DETAILED DESCRIPTION

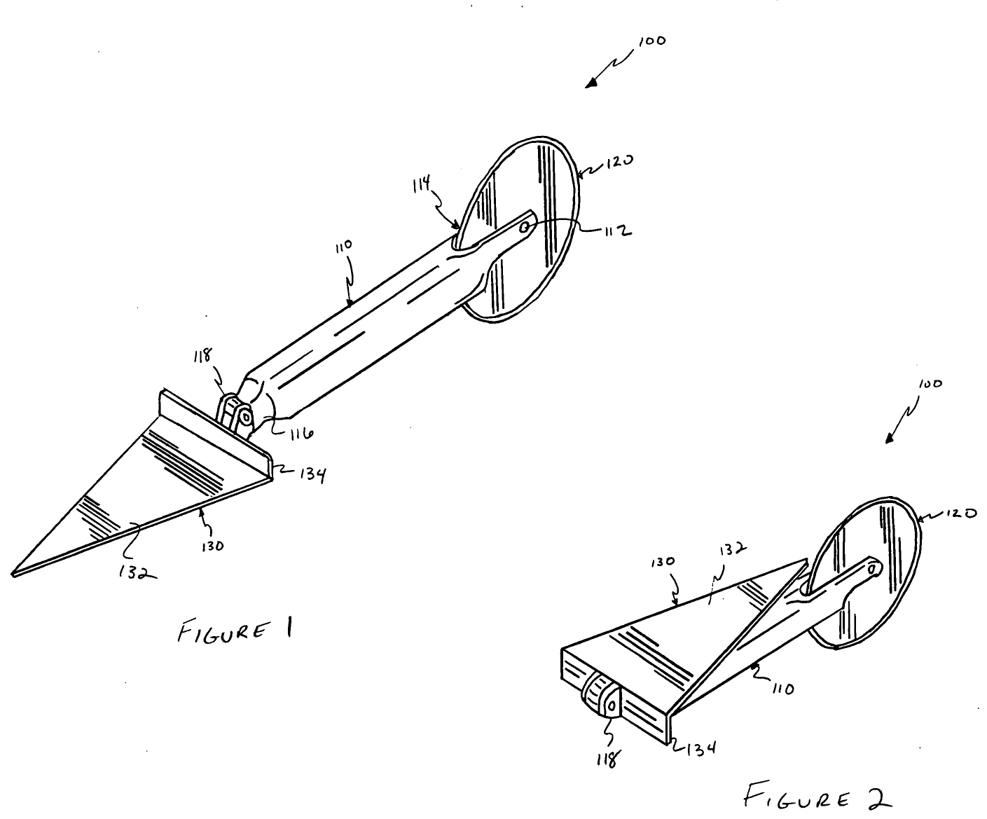

Referring now to the drawings, wherein various elements depicted are not necessarily drawn to scale, and in particular FIGS. 1 and 2 there is illustrated a food cutting and serving utensil 100 constructed according to the principles of the present invention.

As illustrated, food cutting and serving utensil 100 includes a handle 110, a cutting member 120 connected to one end of handle 110, and a serving member 130 connected to the other end of handle 110 generally opposite of cutting member 120.

Handle 110 is generally elongated and is configured to be received into the hand of the user. As can be appreciated, handle 110 can be manufactured out of various types of materials, including, but not limited to, plastics, rubber, wood and metal. It is further contemplated that handle could be manufactured to include various feature to inhibit the slipping of the user's hand during use, such as a rubber coating and various indentations configured to mate with the user's fingers.

Handle 110 includes a bifurcated portion 114 at one end and is configured to receive cutting member 120. Cutting member 120 is a cutting wheel sharpened at the outer perimeter to facilitate the cutting of food. An axle 112 is journaled through the bifurcated end of handle 110 and through the center of cutting member 120, securing cutting member 120 to handle 110. Cutting member 120 has such a diameter to sufficiently extend beyond handle 110 to facilitate the cutting of food of various thicknesses. Axle 112 permits the easy rotation of cutting member 120. As can be appreciated, cutting member 120 could be manufactured out of various materials, including metal and plastic. It is further contemplated that a non-stick coating could be disposed on cutting member 120 to inhibit food from sticking to it.

Handle 110 includes a tapered portion 116 at the end opposite of bifurcated portion 114. Serving member 130 is attached to tapered portion 116 of handle 110 with a hinge mechanism 118. Serving member 130 includes a generally planar triangular shaped portion 132 for receiving thereon a slice of food. A stop 134 extends generally perpendicular to the triangular shaped portion 132 and is connected to hinge 118. Although illustrated in a generally triangular shape, it is contemplated that serving member 130 could be of various shapes and sizes depending upon the desired shape and size of the cut food. For example, some people prefer to cut pizzas in rectangular shapes rather than triangular shapes, as such the present invention could be configured with a generally rectangular shaped serving member 130. As can be appreciated, serving member 130 could be manufactured out of various materials, including metal and plastic. It is further contemplated that a non-stick coating could be disposed on serving member 130 to inhibit food from sticking to it.

Hinge 118 permits the movement of serving member 130 between an open position as illustrated in FIG. 1 and a closed position as illustrated in FIG. 2. Hinge 118 could also be configured with a locking mechanism to secure serving member in either of the open position or closed position.

It is also contemplated that food cutting and serving utensil 100 could be configured such that cutting member 120 and serving member 130 could be easily removed from handle 110 to facilitate easy cleaning of food cutting and serving utensil 100.

An example of the operation of food cutting and serving utensil 100 will now be described with reference to making, cutting and serving of a typical round pizza. Once the pizza has been cooked and removed from the oven, food cutting and serving utensil 100 is placed in the open position (FIG. 1). Handle 110 is gripped by the user such that food cutting and serving utensil 100 is positioned with cutting member 120 proximate to the pizza. The user engages cutting member 120 at the outer edge of the pizza and rolls cutting member 120 through the diameter of the pizza. This is repeated at various spots on the edge of the pizza until the desired number and size of slices is created. The user can then rotate food cutting and serving utensil 100 in their hand, such that serving member 130 is positioned proximate the desired slice of pizza to serve. Serving member is then slid under the desired slice of pizza and lifts it away from the rest of the pizza as is then served. Having a single device to facilitate the cutting and serving of the cut food reduces the amount of clean-up after use, as only one device is used rather than a separate cutter and server. Additionally, with the serving member 130 being moving between an open position and a closed position, when in the closed position, reduces the amount of space needed for storage of food cutting and serving utensil 100.

In the preceding detailed description, reference has been made to the accompanying drawings that form a part hereof, and in which are shown by way of illustration specific embodiments in which the invention may be practiced. These embodiments, and certain variants thereof, have been described in sufficient detail to enable those skilled in the art to practice the invention. It is to be understood that other suitable embodiments may be utilized and that logical changes may be made without departing from the spirit or scope of the invention. The description may omit certain information known to those skilled in the art. The preceding detailed description is, therefore, not intended to be limited to the specific forms set forth herein, but on the contrary, it is intended to cover such alternatives, modifications, and equivalents, as can be reasonably included within the spirit and scope of the appended claims.

What is claimed is:

1. A device for cutting and serving food, comprising:
a handle having a first end and a second end;
a cutting device connected to said first end of said handle; and
a serving device connected to said second end of said handle.

2. The device as recited in claim 1, wherein said first end of said handle is bifurcated.

3. The device as recited in claim 1, wherein said serving device is connected to said second end of said handle with a hinge.

4. The device as recited in claim 3, wherein said hinge facilitates the moving of said serving device with respect to said handle between a first position and a second position.

5. The device as recited in claim 1, wherein said serving device is configured in a generally triangular shape.

6. The device as recited in claim 1, wherein said cutting device is a cutting wheel.

7. The device as recited in claim 2, wherein said cutting device is connected intermediate of said bifurcations with an axel.

8. A pizza cutting and serving device, comprising:
a handle having a first end and a second end;
a cutting device connected to said first end of said handle; and
a serving device movably connected to said second end of said handle.

9. The device as recited in claim 8, wherein said first end of said handle is bifurcated.

10. The device as recited in claim 8, wherein said serving device is movably connected to said second end of said handle with a hinge.

11. The device as recited in claim 10, wherein said hinge facilitates the moving of said serving device with respect to said handle between a first position and a second position.

12. The device as recited in claim 8, wherein said serving device is configured in a generally triangular shape.

13. The device as recited in claim 8, wherein said cutting device is a cutting wheel.

14. The device as recited in claim 9, wherein said cutting device is connected intermediate of said bifurcations with an axel.

15. A pizza cutting and serving device, comprising:
a handle having a first end and a second end;
a cutting device connected to said first end of said handle; and
a serving device connected to said second end of said handle with a hinge.

16. The device as recited in claim 15, wherein said first end of said handle is bifurcated.

17. The device as recited in claim 16, wherein said hinge facilitates the moving of said serving device with respect to said handle between an open position and a closed position.

18. The device as recited in claim 17, wherein said serving device is configured in a generally triangular shape.

19. The device as recited in claim 18, wherein said cutting device includes a cutting wheel.

20. The device as recited in claim 19, wherein said cutting wheel is connected intermediate of said bifurcations with an axel.
